(19) United States
(12) Patent Application Publication
(10) Pub. No.: US 2020/0062248 A1
(43) Pub. Date: Feb. 27, 2020

(54) COLLISION AVOIDANCE ASSIST APPARATUS

(71) Applicant: TOYOTA JIDOSHA KABUSHIKI KAISHA, Toyota-shi (JP)

(72) Inventors: Takashi HASEGAWA, Ashigarakami-gun (JP); Toshinori Okita, Gotemba-shi (JP); Kazuya Saimura, Sunto-gun (JP); Yosuke Yamada, Nagoya-shi (JP)

(73) Assignee: TOYOTA JIDOSHA KABUSHIKI KAISHA, Toyota-shi (JP)

(21) Appl. No.: 16/545,575

(22) Filed: Aug. 20, 2019

(30) Foreign Application Priority Data
Aug. 22, 2018 (JP) 2018-155254

(51) Int. Cl. B60W 30/095; B60W 50/00

(52) U.S. Cl. CPC B60W 30/0953; B60W 2050/0014; B60W 50/0097

(57) ABSTRACT

A collision avoidance assist apparatus is configured to perform a collision avoidance assist operation for avoiding a collision between a moving body and an object if a time to collision, which is a time for the moving body to collide with the object that is around the moving body, is less than or equal to a predetermined threshold value. The collision avoidance assist apparatus is provided with a threshold value changer configured to reduce the predetermined threshold value when an angle made by a straight line in a direction of travel of the moving body and by a straight line in a direction of travel of the object is greater than a predetermined angle, in comparison with when the angle made is less than the predetermined angle.

### CROSS-REFERENCE TO RELATED APPLICATIONS

This application is based upon and claims the benefit of priority of the prior Japanese Patent Application No. 2018-155254, filed on Aug. 22, 2018, the entire contents of which are incorporated herein by reference.

### BACKGROUND

### 1. Technical Field

Embodiments of the present disclosure relate to a collision avoidance assist apparatus configured to assist in avoiding a collision of a vehicle.

### 2. Description of the Related Art

For this type of apparatus, there is known an apparatus configured to perform a driving assist in accordance with a positional relation between a host vehicle and another vehicle. For example, Japanese Patent Application Laid Open No. 2001-243598 (Patent Literature 1) discloses a technology/technique in which an azimuth angle of a surrounding object viewed from a host vehicle is used to estimate a surrounding situation and to perform a driving assist with the content corresponding to the surrounding situation.

Additionally, Japanese Patent Application Laid Open No. 2006-347380 (Patent Literature 2) discloses that the content of a collision prediction control is limited (which is, specifically, that alarming to an occupant is only performed) if an object ahead is confirmed to be an oncoming vehicle.

The collision avoidance assist is desirably performed in accordance with an approaching direction of an object that likely collides with the host vehicle. For example, between when the host vehicle and the object have the same direction of travel and when the host vehicle and the object have different directions of travel, the timing of performing an assist operation is preferably changed, accordingly.

As described in the Patent Literature 1, however, even if information about the azimuth angle of the object (in other words, an angle in a direction in which the object is located, as viewed from the host vehicle) is used, it is hardly possible to obtain the approaching direction of the object with respect to the host vehicle. Thus, if the technology/technique disclosed in the Patent Literature 1 is applied to the collision avoidance assist apparatus, it is hardly possible to perform the assist operation at an appropriate time, which is technically problematic.

### SUMMARY

In view of the aforementioned problem, it is therefore an object of embodiments of the present disclosure to provide a collision avoidance assist apparatus configured to perform a collision avoidance assist operation at an appropriate time.

In an aspect of a collision avoidance assist apparatus according to the present disclosure, it is provided with: an assisting device configured to perform a collision avoidance assist operation for avoiding a collision between a moving body and an object if a time to collision, which is a time for the moving body to collide with the object that is around the moving body, is less than or equal to a predetermined threshold value; and a threshold value changer configured to reduce the predetermined threshold value when an angle made by a straight line in a direction of travel of the moving body and by a straight line in a direction of travel of the object is greater than a predetermined angle, in comparison with when the angle made is less than the predetermined angle.

### BRIEF DESCRIPTION OF THE DRAWINGS

FIG. 1 is a block diagram illustrating a configuration of a vehicle according to an embodiment;

FIG. 2 is a plan view illustrating a method of calculating an angle of a direction of travel performed by an angle calculator;

FIG. 3 is a flowchart illustrating a flow of operations of a collision avoidance assist apparatus according to the embodiment;

FIG. 4 is a map illustrating collision scenes estimated from the angle of the direction of travel and a host vehicle speed;

FIG. 5 is a table illustrating operating threshold values of collision avoidance assist operations corresponding to the collision scenes; and

FIG. 6 is a plan view illustrating an operation of predicting the angle of the direction of travel at a collision time point.

### DETAILED DESCRIPTION OF THE EMBODIMENT

Hereinafter, a collision avoidance assist apparatus according to an embodiment of the present disclosure will be explained with reference to the drawings.

<Configuration of Apparatus>

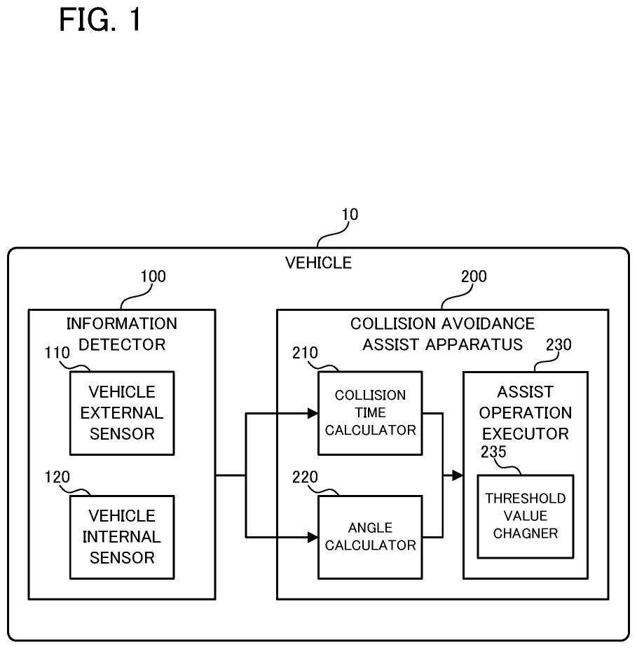

Firstly, a configuration of a vehicle on which the collision avoidance assist apparatus according to the embodiment is mounted will be explained with reference to FIG. 1. FIG. 1 is a block diagram illustrating the configuration of the vehicle according to the embodiment.

As illustrated in FIG. 1, a vehicle 10 according to the embodiment is provided with an information detector 100 and a collision avoidance assist apparatus 200.

The information detector 100 is configured to detect various information about the vehicle 10 and a surrounding situation of the vehicle 10. The information detector 100 is provided with a vehicle external sensor 110 configured to detect information about an outside of the vehicle 10, and a vehicle internal sensor 120 configured to detect information about an inside of the vehicle 10.

The vehicle external sensor 110 may include, for example, an on-vehicle camera, a radar, a Lidar, or the like, and is configured to detect various information about an object (e.g., another vehicle, etc.) that is around the vehicle 10. The vehicle external sensor 110 may detect, for example, a position, a direction, a moving speed or the like of the object that is around the vehicle 10. The various information detected by the vehicle external sensor 110 may be outputted to the collision avoidance assist apparatus 200.

The vehicle internal sensor 120 may include, for example, a vehicle speed sensor, an acceleration sensor, a yaw rate sensor, or the like, and is configured to detect an internal parameter of the vehicle 10. The internal parameter detected by the vehicle internal sensor 120 may be outputted to the collision avoidance assist apparatus 200 (specifically, to each of a collision time calculator 210 and an angle calculator 220).

The collision avoidance assist apparatus 200 is configured to perform a collision avoidance assist operation of assisting in avoiding a collision between the vehicle 10 (hereinafter referred to a “host vehicle 10” as occasion demands) and the object that is around the host vehicle 10. The collision avoidance assist operation may include, for example, an automatic brake control of the host vehicle 10. The collision avoidance assist apparatus 200 is configured, for example, as an electronic control unit (ECU) mounted on the vehicle 10, and is provided with the collision time calculator 210, the angle calculator 220, and an assist operation executor 230, as processing blocks of physical processing circuits for realizing its functions.

The collision time calculator 210 is configured to calculate a time to collision (TTC) on the basis of the information detected by the information detector 100, wherein the TTC is a time for the host vehicle 10 and the object that is around the vehicle 10 (hereinafter referred to as a “surrounding object” as occasion demands) to collide with each other. If there are a plurality of surrounding objects, the collision time calculator 210 may calculate the TTC for each of the objects. A detailed explanation of a method of calculating the TTC is omitted herein because the existing technologies/techniques can be applied, as occasion demands. The TTC calculated by the collision time calculator 210 may be outputted to the assist operation executor 230.

The angle calculator 220 is configured to calculate an angle θ of a direction of travel, which is made by a straight line in a direction of travel of the host vehicle 10 and by a straight line in a direction of travel of the surrounding object, on the basis of the information detected by the information detector 100. The angle θ of the direction of travel will be detailed later. The angle θ of the direction of travel calculated by the angle calculator 220 may be outputted to the assist operation executor 230.

The assist operation executor 230 is configured to perform the collision avoidance assist operation for assisting in avoiding the collision between the host vehicle 10 and the surrounding object, on the basis of the TTC calculated by the collision time calculator 210 and the angle θ of the direction of travel calculated by the angle calculator 220. More specifically, the assist operation executor 230 may determine whether or not the collision avoidance assist operation is to be performed by comparing the TTC with a predetermined operating threshold value, may control the operation of a brake actuator of the host vehicle 10 at an appropriate time at which the collision avoidance assist operation is to be performed, and may perform the automatic brake control (i.e., a brake control that is not by an occupant's operation). The operating threshold value of the collision avoidance assist operation can be changed by a threshold value changer 235. The threshold value changer 235 is configured to change the operating threshold value of the collision avoidance assist operation in accordance with the angle θ of the direction of travel. The assist operation executor 230 is a specific example of the “assisting device” in Supplementary Notes described later. The threshold value changer 235 is a specific example of the “threshold value changer” in Supplementary Notes described later.

<Angle θ of Direction of Travel>

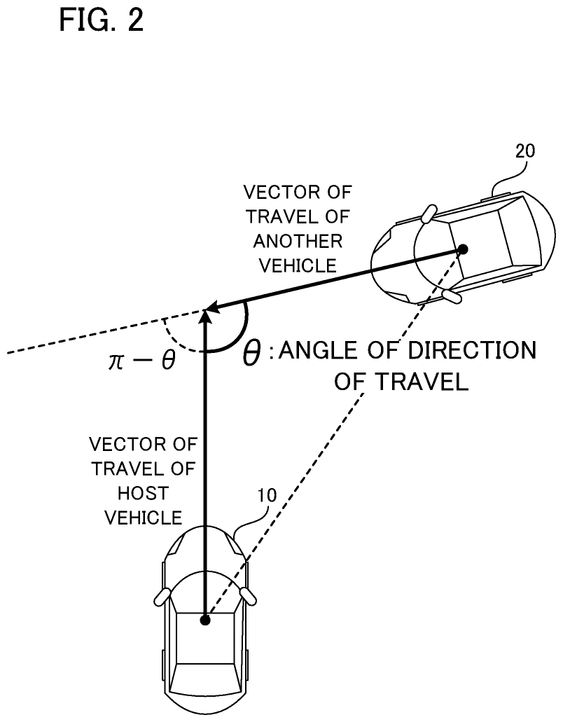

The angle θ of the direction of travel calculated by the angle calculator 220 will be specifically explained with reference to FIG. 2. FIG. 2 is a plan view illustrating a method of calculating the angle of the direction of travel performed by the angle calculator.

As illustrated in FIG. 2, the angle θ of the direction of travel may be calculated as an angle made by a straight line in the direction of travel of the host vehicle 10 and by a straight line in the direction of travel of the surrounding object, wherein FIG. 2 illustrates an example in which another vehicle 20 is the surrounding object. Specifically, the angle θ of the direction of travel may be calculated as an angle made by a vector of travel (a velocity vector) of the host vehicle 10 and a vector of travel of the other vehicle 20. In other words, out of three interior angles of a triangle drawn by the straight line in the direction of travel of the host vehicle 10, the straight line in the direction of travel of the other vehicle 20, and a straight line connecting the host vehicle 10 and the other vehicle 20, the angle θ of the direction of travel may be calculated as an interior angle of an apex at which the straight line in the direction of travel of the host vehicle 10 and the straight line in the direction of travel of the other vehicle 20 cross each other.

The angle θ of the direction of travel may be a value in a range of 0 to 180 degrees; for example, it is “0 degrees” if the host vehicle 10 and the other vehicle 20 have the same direction of travel, and it is “180 degrees” if the host vehicle 10 and the other vehicle 20 have opposite directions of travel. Moreover, as in an example illustrated in FIG. 2, the angle θ of the direction of travel is a value of about 80 to 100 degrees if the other vehicle 20 approaches from the side of the host vehicle 10. In this manner, by using the angle θ of the direction of travel, it is possible to estimate a positional relation and a collision direction of the host vehicle 10 and the other vehicle 20.

Out of the angle made by the straight line in the direction of travel of the host vehicle 10 and the straight line in the direction of travel of the other vehicle 20, an angle different from the aforementioned angle θ of the direction of travel (“π−θ” in FIG. 2) can be also used. This is because “θ” and “π−θ” have a complementary relation, which is that one of them increases while the other decreases, and vice versa. For the same reason, a superior angle (“2π−θ”) when “θ” is an inferior angle, and a superior angle (“2π−(π−θ)”) when “π−θ” is an inferior angle may be also used.

It should be noted, however, that an angle varying direction corresponding to the positional relation between the host vehicle 10 and the other vehicle is opposite between when “θ” and “2π−(π−θ)” are used and when “π−θ” and “2π−θ” are used. In other words, in a situation in which “θ” and “2π−(π−θ)” are relatively large, “π−0” and “2π−θ” are relatively small, and in a situation in which “θ” and “2π−(π−θ)” are relatively small, “π−θ” and “2π−θ” are relatively large. Thus, in a determination process using a magnitude of the angle θ of the direction of travel described later, a magnitude relation (or a sign of inequality) needs to be opposite for the determination between when “θ” and “2π−(π−θ)” are used and when “π−θ” and “2π−θ” are used.

<Explanation of Operation>

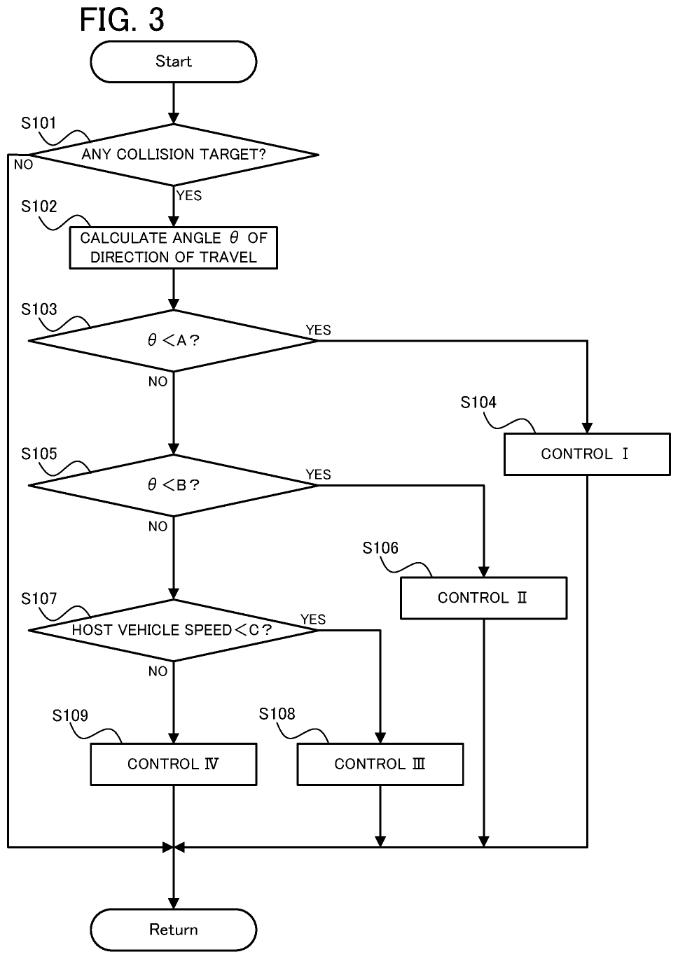

Next, a flow of operations of the collision avoidance assist apparatus according to the embodiment will be explained with reference to FIG. 3. FIG. 3 is a flowchart illustrating the flow of the operations of the collision avoidance assist apparatus 200 according to the embodiment.

As illustrated in FIG. 3, in operation of the collision avoidance assist apparatus 200 according to the embodiment, firstly, the collision time calculator 210 calculates the TTC for the surrounding object of the host vehicle 10, and determines whether or not there is any surrounding object that likely collides with the host vehicle 10 at a current time point (hereinafter referred to as a “collision target” as occasion demands) (step S101). The collision time calculator 210 may determine an object that is a moving body and that likely collides with the host vehicle 10 (e.g., a surrounding object having a TTC that is less than a predetermined time, from surrounding objects, to be the collision target. Hereinafter, an explanation will be given with the other vehicle 20 as an example of the “collision target”. If it is determined that there is no collision target (the step S101: NO), the subsequent process is omitted, and a series of operation steps is ended. In this case, the collision avoidance assist apparatus 200 may restart the step S101 after a lapse of a predetermined period.

If it is determined that there is the collision target (the step S101: YES), the angle calculator 220 calculates the angle θ of the direction of travel of the host vehicle 10 and the collision target (refer to FIG. 2) (step S102). The angle θ of the direction of travel may be calculated by using, for example, a position, a direction, and a speed of the collision target detected by the vehicle external sensor 110, or the like.

The assist operation executor 230 then determines whether or not the angle θ of the direction of travel calculated by the angle calculator 220 is less than a threshold value A (step S103). The threshold value A is a threshold value for determining whether or not a collision scene assumed from the positional relation between the host vehicle 10 and the collision target is a “rear-end collision/cut-in”. The “rear-end collision” herein may be a scene in which the host vehicle 10 collides with the other vehicle 20 that travels on the same driving lane as that of the host vehicle 10. The “cut-in” may be a scene in which the host vehicle 10 collides with the other vehicle 20 that cuts in from the outside of the driving lane (e.g., a passing vehicle, etc.). In the case of the “rear-end collision/cut-in”, it is considered that the angle θ of the direction of travel is calculated as a value that is extremely close to 0 degrees, because the host vehicle 10 and the collision target have substantially the same direction of travel. Thus, if the threshold value A is set at a value that is slightly greater than 0 degrees, it is possible to determine whether or not the collision scene is the “rear-end collision/cut-in”. The threshold value A is a specific example of the “predetermined angle” described later.

Instead of the angle θ of the direction of travel, each of “π−θ”, “2π−θ”, and “2π−(π−θ)” may be used, as described above. If “π−θ”, “2π−θ”, and “2π−(π−θ)” are used, in the step S103, “π−A”, “2π−A”, and “2π−(π−A)” are respectively used, instead of the threshold value A. In other words, if “π−θ”, “2π−θ”, or “2π−(π−θ)” is used, in the step S103, the assist operation executor 230 determines whether or not “π−θ” is greater than “n−A”, whether or not “2π−θ” is greater than “2π−A”, or whether or not “2π−(π−θ)” is less than “2π−(π−A)”. In this case, any of the determinations is substantially equivalent to the operation of determining whether or not the angle θ of the direction of travel is less than the threshold value A. In other words, it can be said that the assist operation executor 230 substantially determines whether or not the angle θ of the direction of travel is less than the threshold value A, even when each of “π−θ”, “2π−θ”, and “2π−(π−θ)” are used.

If it is determined that the angle θ of the direction of travel is less than the threshold value A (or that (π−θ) is greater than (π−A), or that (2π−θ) is greater than (2π−A), or that (2n−(π−θ)) is less than (2π−(π−A)) (the step S103: YES), the assist operation executor 230 performs a control I corresponding to the “rear-end collision/cut-in” (step S104).

If it is determined that the angle θ of the direction of travel is not less than the threshold value A (or that (π−θ) is not greater than (π−A), or that (2π−θ) is not greater than (2π−A), or that (2π−(π−θ)) is not less than (2π−(π−A)) (the step S103: NO), the assist operation executor 230 determines whether or not the angle θ of the direction of travel is less than a threshold value B (step S105). The threshold value B is a threshold value for determining whether or not the collision scene assumed from the positional relation between the host vehicle 10 and the collision target is a “moment of an encounter”, and is set as a value that is greater than the threshold value A. The “moment of the encounter” herein may be a scene in which, for example, at a crossing, the host vehicle 10 collides with the other vehicle 20 that travels on a lane that crosses the driving lane on which the host vehicle 10 travels. In the case of the “moment of the encounter”, it is considered that the angle θ of the direction of travel is calculated as a value that is at most about 150 degrees, because in many cases, the direction of travel of the host vehicle 10 crosses the direction of travel of the collision target. Thus, if the threshold value B is set at a value that is close to 150 degrees, it is possible to determine whether or not the collision scene is the “moment of the encounter”. The threshold value B is also a specific example of the “predetermined angle” described later, as in the threshold value A.

Instead of the angle θ of the direction of travel, each of “π−θ”, “2π−θ”, and “2π−(π−θ)” may be used, as described above. If “π−θ”, “2π−θ”, and “2π−(π−θ)” are used, in the step S105, “π−B”, “2π−B”, and “2π−(π−B)” are respectively used, instead of the threshold value B. In other words, if “π−θ”, “2π−θ”, or “2π−(π−θ)” is used, in the step S105, the assist operation executor 230 determines whether or not “π−θ” is greater than “π−B”, whether or not “2π−θ” is greater than “2π−B”, or whether or not “2π−(π−θ)” is less than “2π−(π−B)”. In this case, any of the determinations is substantially equivalent to the operation of determining whether or not the angle θ of the direction of travel is less than the threshold value B. In other words, it can be said that the assist operation executor 230 substantially determines whether or not the angle θ of the direction of travel is less than the threshold value B, even when each of “π−θ”, “2π−θ”, and “2π−(π−θ)” are used.

If it is determined that the angle θ of the direction of travel is less than the threshold value B (or that (π−θ) is greater than (π−B), or that (2π−θ) is greater than (2π−B), or that (2π−(π−θ)) is less than (2π−(π−B)) (the step S105: YES), the assist operation executor 230 performs a control II corresponding to the “moment of the encounter” (step S106).

If it is determined that the angle θ of the direction of travel is not less than the threshold value B (or that (π−θ) is not greater than (π−B), or that (2π−θ) is not greater than (2π−B), or that (2π−(π−θ)) is not less than (2π−(π−B)) (the step S105: NO), the assist operation executor 230 determines whether or not a speed of the host vehicle 10 (hereinafter referred to as a “host vehicle speed” as occasion demands) is less than a threshold value C (step S107). The threshold value C is a threshold value for determining whether or not the collision scene is a “right-turn and go-straight”, or an “oncoming vehicle”. The “right-turn and go-straight” herein may be a scene in which the host vehicle 10 that turns right collides with the other vehicle 20 that goes straight on an opposite lane. The “oncoming vehicle” may be a scene in which either one of the host vehicle 10 that travels on the driving lane and the other vehicle 20 that travels on the opposite lane deviates from the lane and the host vehicle 10 and the other vehicle 20 collide with each other. In the case of the “right-turn and go-straight” or the “oncoming vehicle”, the two cases are hardly distinguished only by the angle θ of the direction of travel, because the host vehicle 10 and the collision target have almost opposite directions of travel. In the case of the “right-turn and go-straight”, however, the host vehicle 10 is considered to reduce the host vehicle speed to be slow enough to turn right, while in the case of the “oncoming vehicle”, the vehicle speed of the host vehicle 10 is considered to remain relatively high. Thus, if the threshold value C for the host vehicle speed is used, it is possible to determine whether or not the collision scene is the “right-turn and go-straight” or the “oncoming vehicle”.

If it is determined that the host vehicle speed is less than the threshold value C (the step S107: YES), the assist operation executor 230 performs a control III corresponding to the “right-turn and go-straight” (step S108). On the other hand, if it is determined that the host vehicle speed is not less than the threshold value C (the step S107: NO), the assist operation executor 230 performs a control IV corresponding to the “oncoming vehicle” (step S109).

<Technical Effect>

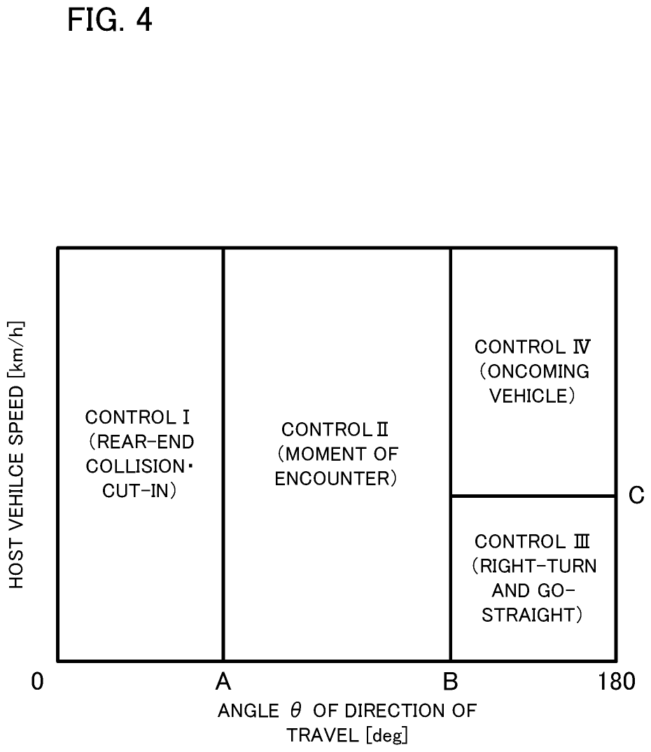

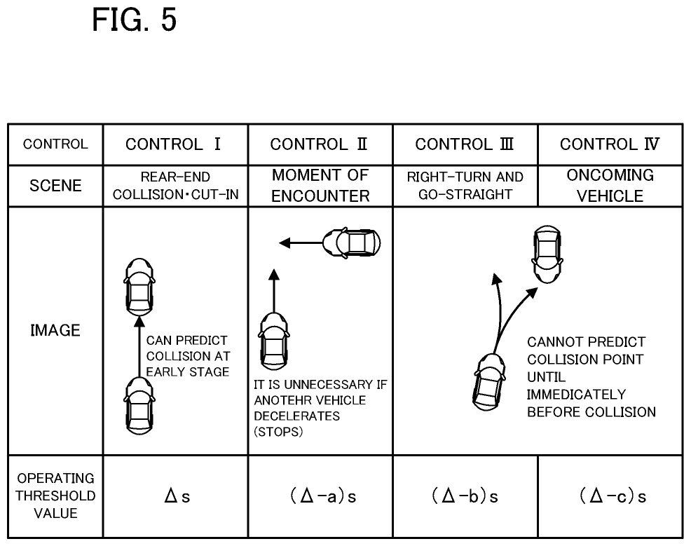

Next, a technical effect obtained by the collision avoidance assist apparatus 200 according to the embodiment will be explained with reference to FIG. 4 and FIG. 5. FIG. 4 is a map illustrating the collision scenes estimated from the angle of the direction of travel and the host vehicle speed. FIG. 5 is a table illustrating operating threshold values of collision avoidance assist operations corresponding to the collision scenes.

As illustrated in FIG. 4, in the collision avoidance assist apparatus 200 according to the embodiment, the collision scenes are classified into four types in accordance with the angle θ of the direction of travel and the host vehicle speed, and the control corresponding to each scene is performed. Specifically, if the angle θ of the direction of travel is less than the threshold value A, the control I corresponding to the “rear-end collision/cut-in” is performed. If the angle θ of the direction of travel is greater than or equal to the threshold value A and is less than the threshold value B, the control II corresponding to the “moment of the encounter” is performed. If the angle θ of the direction of travel is greater than or equal to the threshold value B and is less than the threshold value C, control III corresponding to the “right-turn and go-straight” is performed. If the angle θ of the direction of travel is greater than or equal to the threshold value B and is greater than the threshold value C, control IV corresponding to the “oncoming vehicle” is performed.

As illustrated in FIG. 5, in the case of the “rear-end collision/cut-in”, the host vehicle 10 and the other vehicle 2—have substantially the same direction of travel, and thus, the occurrence of the collision can be predicted at a relatively early stage. Thus, even if the collision avoidance assist operation is performed at a relatively early time, it is less likely an unnecessary operation (in other words, unnecessary deceleration). Thus, in the control I corresponding to the “rear-end collision/cut-in”, the threshold value changer 235 sets a reference value Δ sec for the predetermined operating threshold value to be compared with the TTC. By this, in performing the control I, the collision avoidance assist operation is performed at a time point at which the TTC becomes less than or equal to Δ sec.

In the case of the “moment of the encounter”, although there is a possibility of the collision if the other vehicle 20 travels without decelerating toward the host vehicle 10 that goes straight, but there is also a possibility of avoiding the collision if the other vehicle 20 that notices the presence of the host vehicle 10 decelerates (or stops). Thus, if the collision avoidance assist operation is performed at the same time as that in the case of the “rear-end collision/cut-in”, it is likely an unnecessary operation. Thus, in the control II corresponding to the “moment of the encounter”, the threshold value changer 235 sets (Δ−a) sec for the predetermined operating threshold value to be compared with the TTC, wherein a is a positive value. By this, in performing the control II, the collision avoidance assist operation is performed at a time point at which the TTC becomes less than or equal to (Δ−a) sec. In other words, in the case of the “moment of the encounter”, in comparison with the case of “rear-end collision/cut-in”, the execution timing of the collision avoidance assist operation is delayed (in other words, the collision avoidance assist operation is hardly performed) to the extent that the operating threshold value is reduced. It is therefore possible to reduce such a possibility that the collision avoidance assist operation is an unnecessary operation.

In the case of the “right-turn and go-straight” and the “oncoming vehicle”, the possibility of the collision significantly varies depending on which courses the host vehicle 10 and the other vehicle 20 take. It is thus hard to predict a collision point, i.e., a position in which the host vehicle 10 collides with the oncoming vehicle 20, until immediately before the collision, and it is not easy to accurately calculate the TTC. Thus, if the collision avoidance assist operation is performed at the same time as those of the “rear-end collision/cut-in” and the “moment of the encounter”, it is likely an unnecessary operation. Thus, in the control III corresponding to the “right-turn and go-straight”, the threshold value changer 235 sets (Δ−b) sec for the predetermined operating threshold value to be compared with the TTC, wherein b>a. By this, in performing the control III, the collision avoidance assist operation is performed at a time point at which the TTC becomes less than or equal to (Δ−b) sec. In the same manner, in the control IV corresponding to the “oncoming vehicle”, the threshold value changer 235 sets (Δ−c) sec for the predetermined operating threshold value to be compared with the TTC, wherein c>a. By this, in performing the control IV, the collision avoidance assist operation is performed at a time point at which the TTC becomes less than or equal to (Δ−c) sec. In other words, in the case of the “right-turn and go-straight” and the “oncoming vehicle”, in comparison with the case of “moment of the encounter”, the execution timing of the collision avoidance assist operation is further delayed. It is therefore possible to reduce such a possibility that the collision avoidance assist operation is an unnecessary operation.

For the values “a”, “b”, and “c”, which are respectively subtracted from the reference value Δ in the controls II to IV, appropriate values may be determined by advanced simulations assuming the respective collision scenes, or the like. A magnitude relation between b and c is not limited. Thus, b=c may be set if it is determined that there is the same possibility of the occurrence of an unnecessary operation in both the case of “right-turn and go-straight” and the case of the “oncoming vehicle”, or b<c may be set if it is determined that there is a lower possibility of the occurrence of an unnecessary operation in the case of “right-turn and go-straight” than in the case of the “oncoming vehicle”, or b>c may be set if it is determined that there is a higher possibility of the occurrence of an unnecessary operation in the case of “right-turn and go-straight” than in the case of the “oncoming vehicle”.

As explained above, in the collision avoidance assist apparatus 200 according to the embodiment, the operating threshold value of the collision avoidance assist operation is changed to be less, in the collision scene in which the angle θ of the direction of travel increases. By this, the execution timing of the collision avoidance assist operation is further delayed in the scene in which it is harder to predict the collision at an early stage, which results in a reduction in the occurrence of an unnecessary operation.

In the collision avoidance assist apparatus 200 according to the embodiment, the four collision scenes in total are assumed, but the number of the threshold values for classifying the collision scenes may be reduced, and controls corresponding to two or three collision scenes may be performed. Alternatively, by setting more threshold values, the control may be performed with the collision scenes classified into five or more scenes. In the embodiment, an explanation was given to the example of changing the threshold values regarding the TTC. In addition to this, a threshold value regarding a positional relation with the surrounding object to be used for collision determination, a brake control amount in the collision avoidance assist operation, or the like may be changed.

### Modified Example

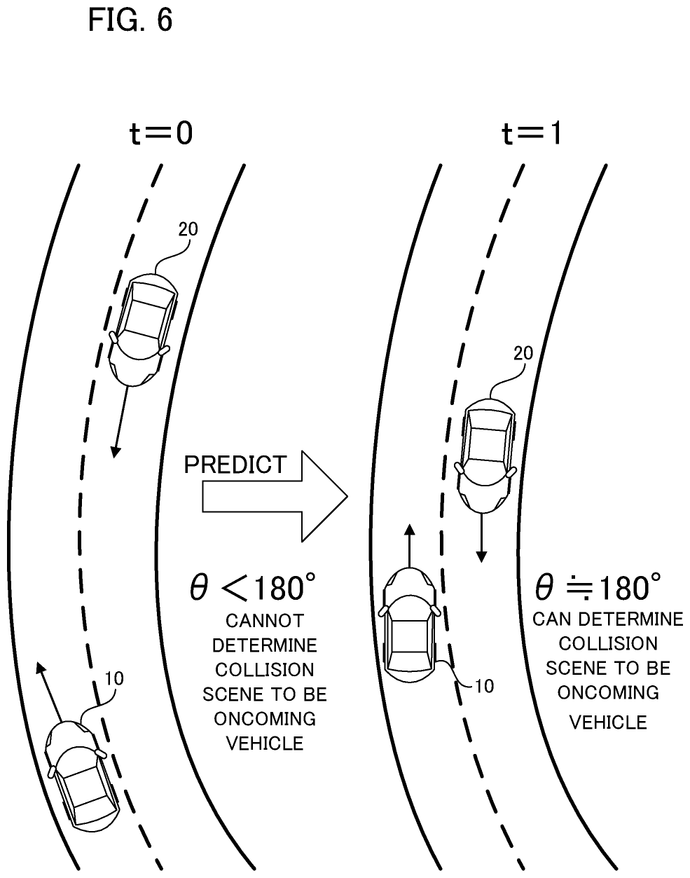

Next, a modified example of the collision avoidance assist apparatus 200 according to the embodiment will be explained with reference to FIG. 6. FIG. 6 is a plan view illustrating an operation of predicting the angle of the direction of travel at a collision time point.

An example illustrated in FIG. 6 shows a situation in which the other vehicle 20 that travels on the opposite lane approaches the host vehicle 10 and it should be determined that the collision scene is the “oncoming vehicle”. However, at a stage at which a distance between the host vehicle 10 and the other vehicle 20 is relatively far (at t=0), the angle θ of the direction of travel is less than the threshold value B, and it is hard to determine the collision scene to be the “oncoming vehicle” depending on the threshold value.

In contrast, the angle calculator 220 according to the modified example is configured to estimate the angle θ of the direction of travel at a time at which the host vehicle 10 and the other vehicle 20 collide (at t=1). Specifically, the angle calculator 220 may obtain road information (e.g., information about a curve, etc.) in addition to the various information about the host vehicle 10 and the other vehicle 20, may predict the directions of travel of the host vehicle 10 and the other vehicle 20 in collision timing, and may calculate the angle θ of the direction of travel from them. In this case, the angle calculator 220 is a specific example of the “estimator” in Supplementary Notes described later.

As is clear from FIG. 6, the angle θ of the direction of travel at t=1 is calculated as a value that is extremely close to 180 degrees. Thus, the assist operation executor 230 can accurately determine that the collision scene is the “oncoming vehicle”. It is therefore possible to appropriately change the operating threshold value of the collision avoidance assist operation in accordance with the collision scene, and it is possible to effectively reduce the unnecessary operation.

<Supplementary Notes>

Various aspects of embodiments of the present disclosure derived from the embodiment explained above will be explained hereinafter.

(Supplementary Note 1)

A collision avoidance assist apparatus described in Supplementary Note 1 is provided with: an assisting device configured to perform a collision avoidance assist operation for avoiding a collision between a moving body and an object if a time to collision, which is a time for the moving body to collide with the object that is around the moving body, is less than or equal to a predetermined threshold value; and a threshold value changer configured to reduce the predetermined threshold value when an angle made by a straight line in a direction of travel of the moving body and by a straight line in a direction of travel of the object is greater than a predetermined angle, in comparison with when the angle made is less than the predetermined angle.

According to the collision avoidance assist apparatus described in Supplementary Note 1, the predetermined threshold value for performing the collision avoidance assist operation is changed in accordance with the angle made by the straight line in the direction of travel of the moving body and by the straight line in the direction of travel of the object. Particularly herein, the angle made may vary depending on a collision scene between the moving body and the object. It is thus possible to easily determine the collision scene by using the angle made. It is therefore possible to change the predetermined threshold value to an appropriate value corresponding to the collision scene, and it is possible to perform the collision avoidance assist operation at an appropriate time. By this, it is possible to reduce such a possibility that the collision avoidance assist operation is an unnecessary operation.

(Supplementary Note 2)

A collision avoidance assist apparatus described in Supplementary Note 2 is further provided with an estimator configured to estimate the angle made after a lapse of a predetermined period, wherein the threshold value changer is configured to reduce the predetermined threshold value when the angle made after the lapse of the predetermined period is greater than the predetermined angle, in comparison with when the angle made after the lapse of the predetermined period is less than the predetermined angle.

According to the collision avoidance assist apparatus described in Supplementary Note 2, the angle made after the lapse of the predetermined period (e.g., in collision timing) is estimated. It is thus possible to determine the collision scene more accurately than when the angle made at a current time point is used without a change, and it is possible to change the predetermined threshold value to a more appropriate value. By this, it is possible to reduce such a possibility that the collision avoidance assist operation is an unnecessary operation.

The present disclosure may be embodied in other specific forms without departing from the spirit or essential characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. A collision avoidance assist apparatus comprising:
an assisting device configured to perform a collision avoidance assist operation for avoiding a collision between a moving body and an object if a time to collision, which is a time for the moving body to collide with the object that is around the moving body, is less than or equal to a predetermined threshold value; and
a threshold value changer configured to reduce the predetermined threshold value when an angle made by a straight line in a direction of travel of the moving body and by a straight line in a direction of travel of the object is greater than a predetermined angle, in comparison with when the angle made is less than the predetermined angle.

2. The collision avoidance assist apparatus according to claim 1, further comprising an estimator configured to estimate the angle made after a lapse of a predetermined period, wherein
said threshold value changer is configured to reduce the predetermined threshold value when the angle made after the lapse of the predetermined period is greater than the predetermined angle, in comparison with when the angle made after the lapse of the predetermined period is less than the predetermined angle.
